(19) United States
(12) Patent Application Publication
(10) Pub. No.: US 2011/0260127 A1
(43) Pub. Date: Oct. 27, 2011

(54) Tree mounted hoist

(76) Inventors: David K. Surgeon, Punta Gorda, FL (US); Michael Lapham, Punta Gorda, FL (US)

(21) Appl. No.: 12/799,441

(22) Filed: Apr. 26, 2010

(51) Int. Cl. B66D 3/26; B66D 3/20

(52) U.S. Cl. 254/362; 254/380

(57) ABSTRACT

The inventive concept involves a tree mounted hoist that can be attached to a tree at any desired height. The tree hoist consists of a support platform that has an electric motor therein. The other direction of the support platform has a plate that has serrated teeth thereon that will dig into a tree when forced thereat. The support platform has an upstanding frame thereon and the ends of the upstanding frame each have a locking sleeve thereon. The locking sleeve each receive the end of a flexible cable that surrounds the tree and when tightened around the tree stabilizes the support platform on the tree. The support platform has a forward extension thereon that has a cable pulley at its forward ends over which a hoist cable is trained which hoist cable connects to a winch which is operated by the motor. The electric motor is a 12 Volt vehicle starter motor which can be operated by a remote switch. The battery for operating the electric motor is located in a remote location, possibly, the battery of an attending vehicle.

### BACKGROUND OF THE INVENTION

The present invention relates to a portable hoist that can be mounted on any upstanding post such as a tree, a lamp post, a telephone post and many others. The main purpose of the hoist is to be used while on a hunting expedition and large animals that are bagged can be hoisted into an appropriate vehicle or conveyance. Various tree or otherwise mounted hoist are known:

U.S. Pat. No. 6,739,964 presents and discloses such a hoist. However, this disclosed tree hoist cannot be termed as self-contained because as it is mounted on a tree the hoist platform is located in one location up on the tree, while the hand-cranked mechanism is located at another location closer to the ground so that a person operating the hoist can reach the hand crank.
U.S. Pat. No. 3,894,313 shows a game hoist that is mounted on the ground.
U.S. Pat. No. No. 4,806,063 disclose a hoist that is mounted on a vehicle.
U.S. Pat. No. No. 5.049110 shows and teaches a portable game support.
U.S. Pat. No. No. 5,395,284 discloses a self-contained hoist that is hand operated.
U.S. Pat. No. No. 5,562,534 discloses a self-contained hoisting unit that is operated by a hand crank.
U.S. Pat. No. No. 6,045,442 shows a wall mounted hoist with a hand crank remote from the hoist.
U.S. Pat. No. No. 6,264,544 shows a game weighing system for game that is supported on the ground.

### BRIEF DESCRIPTION OF THE INVENTION

The present inventive concept is directed toward a hoist that can be mounted on any upstanding pole, such as, a tree, a light post, a telephone pole or any other upstanding post or pole. The hoist is self-contained and is mounted on a tree for this example. The mounting consists of flexible contrivance that surrounds the tree or any upstanding post to snugly fasten the device to a tree. On the other side of the contrivance there is plate with serrated teeth that digs into the surface of the post to stabilize it. There is a support platform on the hoisting device that contains the motive power to lower or raise a load by way of a hoist line coming from a winch which is operated by the motor. This arrangement is called a self-contained hoisting system.

### BRIEF DESCRIPTION OF THE DRAWINGS

FIG. 1 is top view of the hoisting system;

FIG. 2 is a front view of the system of FIG. 1;

FIG. 3 is a side view of the hoisting system of FIGS. 1 and 2;

FIG. 4 is a perspective view of the hoisting system;

FIG. 5 is a perspective view of the hoisting system installed on a tree trunk.

### DETAILED DESCRIPTION OF THE INVENTION

FIG. 1 is a top view of the tree hoist and it shows an arresting plate 1 which will be resting against the tree or any wooden post and it will be arrested at this location by way of the serrated teeth 2 that will dig into the wood to some extent. In an opposite direction from the plate 1 there is a support platform 3. The purpose of the platform 3 will be explained below. The support platform is stabilized in a substantially horizontal position by cables 4 and 5 which are fastened to an upstanding frame 20 and 21 which is formed by a bottom horizontal stud. This frame 20 and 21 is rigidified by triangular studs 23 and 24. Once a predetermined position is found on the tree or wooden pole, the hoist will be fastened to the tree or wooden pole by a flexible cable 6 which surrounds the tree. The flexible cable consists of a motor cycle chain that is contained in a plastic tube. The ends of the chain can be seen at 7 and 8 and are useful to be grasped to tighten the flexible cable 6 against the tree and causes the serrated teeth 2 to dig into the wood to make a steady hoist platform. The other ends of the stabilizing cables 4 and 5 are also attached to a forwardly extending stud 10 which has a pulley 12 attached to a forward end. On the support platform 3 there is an electric motor 9 mounted thereon which has a winch 9a attached thereto. The winch 9a drives a hoist cable 11 up or down depending, of course, of the rotation of the motor 9.

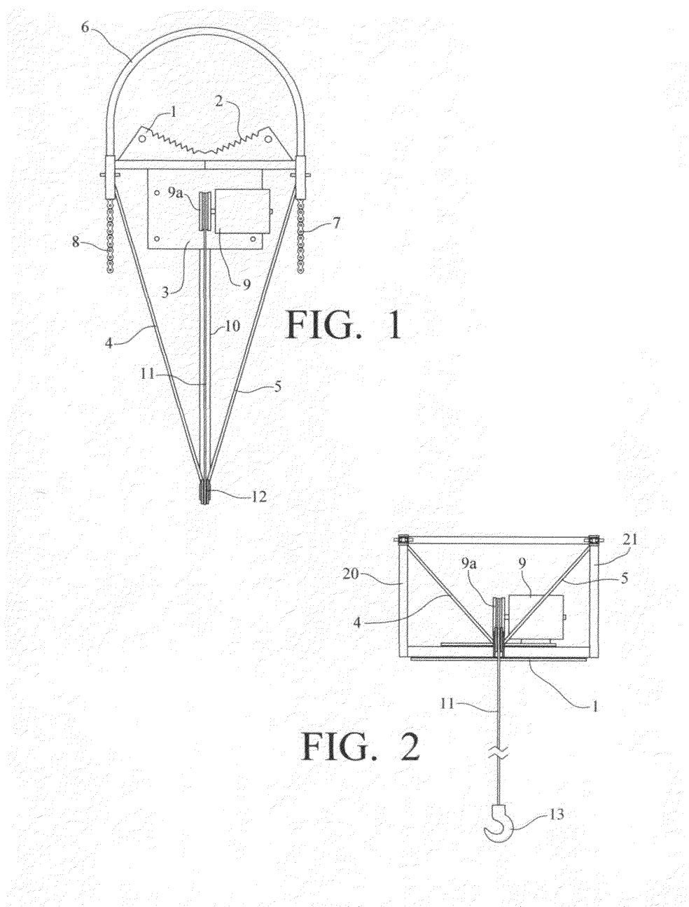

FIG. 2 shows the hoist from a front view with the same reference characters appearing as were applied in FIG. 1. The hoist cable 11 has at its lower end a hook 13 attached thereto which will attach to the loads to be lifter. This will be explained below.

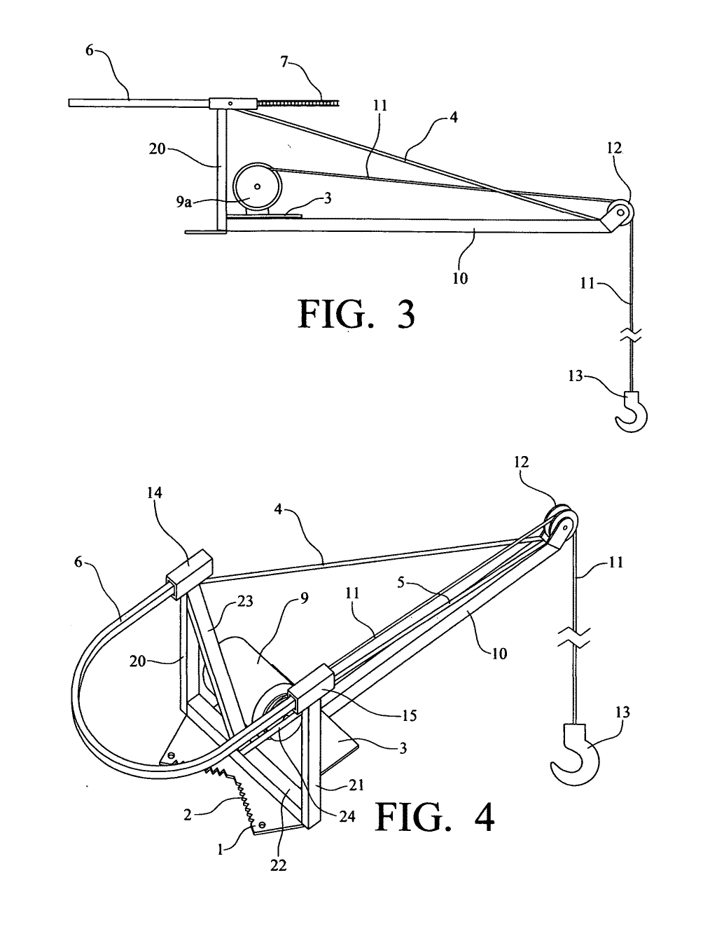

FIG. 3 is a side view of the hoist shown in FIGS. 1 and 2. Again, the same reference characters are applied as were applied in the previous FIGS. 1 and 2.

FIG. 4 is a perspective view of the hoist. In this view the upstanding frame is shown. This frame consists of a bottom and horizontal stud 22 which is attached to the support platform 3 and has at its ends two upstanding studs 20 and 21. The upstanding studs 20 and 21 is stabilized by two studs 23 and 24 which are fastened each to the top of the upstanding studs 20 and 21, respectively. The stabilizing studs 23 and 24 converge downwardly and meet at the center of the bottom stud 22. Also shown at the top of the two upstanding studs 23 and 24 are two locking sleeves 14 and 15. These two locking sleeves each receive an end of flexible cable 6 that surrounds the tree once the hoist is installed. The ends of flexible cable 6 can be locked in the respective sleeves once the cable surrounds the tree. It can be seen that many differently sized trees or wooden poles can be used to install the hoist. Those tree and poles can have many different circumferences.

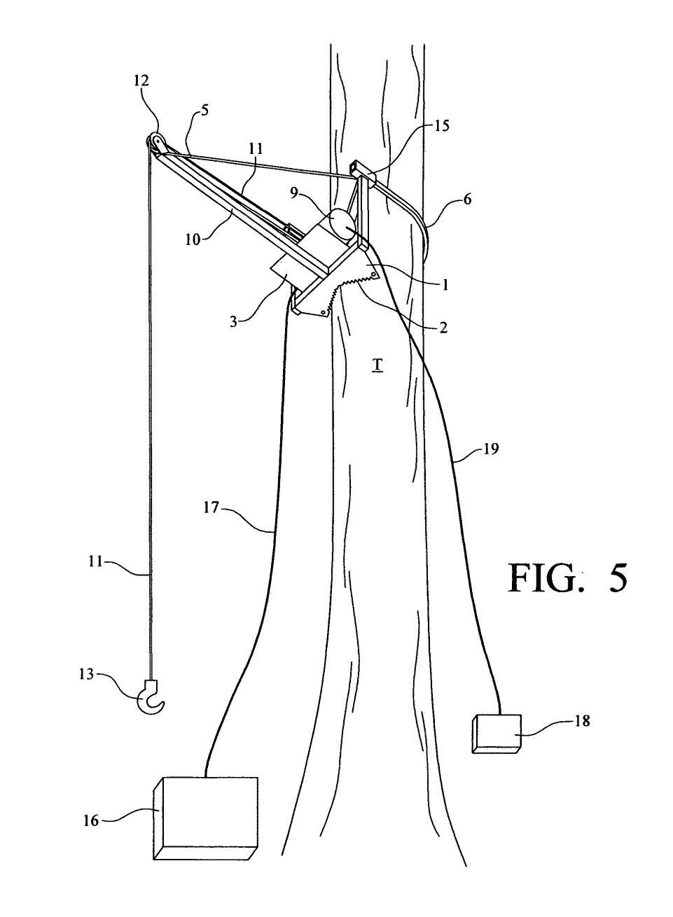

FIG. 5 is a perspective view of the hoist installed on a tree. In this view it can be seen that the serrated teeth 2 have dug into the tree T and the hoist is supported and stabilized by the flexible cable 6 which surrounds the tree. The electric motor can be operated by a battery which could be placed on the support platform 3. On the other hand a battery of a vehicle, which battery is symbolically shown 16, and is connected to the electric motor 9 by way of an electric cable 17. The electric motor 9 can be manually activated by way of switch 18 which is connected to the motor 9 by way of a cable 19. The same activation could be undertaken by way of remote operation which is well known.

Operation

The hoist, once installed on a tree or any other wooden post, can be used for many purposes. A hunter could use the hoist to hoist a cadaver of heavy animal into a vehicle. It is also envisioned that the hoist can be used while enjoying the riding of ATVs in the landscape. Once finished, the ATV can be hoisted into the bed of a pick-up truck or a flatbed truck to be transported on regular roads. Of course, the battery of the transporting vehicle can be used to operate the electric motor. For this purpose, the electric motor 9 on the support platform 3 should be a 12 Volt starter motor as is used in the vehicle. A starter motor has enough torque to operate the winch 9a to haul in or out the hoist cable 11 even with a heavy load thereon. The electric switch 18 can be used to operate the motor 9. Instead of the manual cable connected switch 18 a remote switch can be used. The hoist lends itself very well in a lumber operation where cut tree stumps must be loaded onto a vehicle. It does not matter what kind of a vehicle is used for this purpose because the hoist can be installed at many different heights on a tree. The vehicle battery could be used for this purpose.

What we claim is:

1. A tree hoist for loading items onto a transport, the hoist including a support platform having an electric motor thereon, said support platform having a serrated edge plate pointing into a different direction toward said tree, an upstanding frame is mounted on said platform and is lockingly supporting ends of a flexible cable thereon, said flexible cable is surrounding said tree and stabilizing said hoist into an operable status.

2. The tree hoist of claim 1, wherein said electric motor drives a winch which pays in and out a hoist cable.

3. The tree hoist of claim 1, wherein said upstanding frame has a bottom and horizontal stud and two upstanding studs are mounted at each of the ends of the horizontal stud, said two upstanding studs are stabilized by two studs which each converge downwardly and meet at a center of said horizontal stud.

4. The tree hoist of claim 1, wherein each of said two ends of said flexible cable are received in a locking sleeve located on top of said upstanding studs.

5. The tree hoist of claim 1, wherein said electric motor on said support platform is operated by a battery from a remote location.

6. The tree hoist of claim 5 wherein said electric motor is activated by a switch at a remote location.

7. The tree hoist of claim 1 wherein said electric motor is a 12 Volt vehicle starter motor.

8. The tree hoist of claim 2, wherein said support platform has a forward extension therein including a cable pulley at its forward end over which said hoist cable is trained to extend downwardly toward the ground where a load is located to be hoisted.
